(19) United States
(12) Patent Application Publication
(10) Pub. No.: US 2011/0293981 A1
(43) Pub. Date: Dec. 1, 2011

(54) MOBILE DEVICE HAVING A WATERPROOF STRUCTURE

(75) Inventors: XIN-LONG FANG, Shanghai (CN); ZHONG-YOU LI, Shanghai (CN); PENG JIN, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 12/975,219

(22) Filed: Dec. 21, 2010

(30) Foreign Application Priority Data
May 31, 2010 (CN) 201010187212.7

(51) Int. Cl. H01M 2/10

(52) U.S. Cl. 429/100

(57) ABSTRACT

A mobile device includes a housing, a gasket and a lid assembly. The housing defines receiving chamber to receive a battery and a receiving groove configured in a circle around the receiving chamber. The gasket is received in the receiving groove. The lid assembly attached to the housing to cover the receiving chamber includes a first lid and a second lid. The first lid includes a projecting rib to engage with the receiving groove to force the gasket in the receiving groove. The second lid is slideably attached to the first lid and engages to the housing to force the first lid on the housing.

### BACKGROUND

1. Technical Field

The present disclosure generally relates to mobile devices, and more particularly to a waterproof structure between a housing defining a battery chamber to receive a battery and a lid assembly covering the battery chamber.

2. Description of Related Art

Recently, use of mobile devices such as mobile phones and handheld video game machines has greatly increased. Most of such mobile devices employ batteries as power sources.

While these mobile devices such as mobile phones incorporate more sophisticated functions, the device size and weight are further reduced. Nowadays, a demand for a waterproof function is raised. Generally, the mobile device defines a battery chamber for receiving a battery therein, therefore, how to structure the battery chamber for waterproof purposes poses a problem.

Therefore, a need exists in the industry to overcome the described problem.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, perspective view of a mobile device of an exemplary embodiment of the disclosure.

FIG. 2 is an assembled, perspective view of FIG. 1.

FIG. 3 is a perspective view of a lid assembly comprising a first lid and a second lid of FIG. 1.

FIG. 4 is a perspective view of the first cover of FIG. 3.

FIG. 5 is a perspective view of the second cover of FIG. 3.

FIG. 6 is an enlarged, partial cutaway view of FIG. 3.

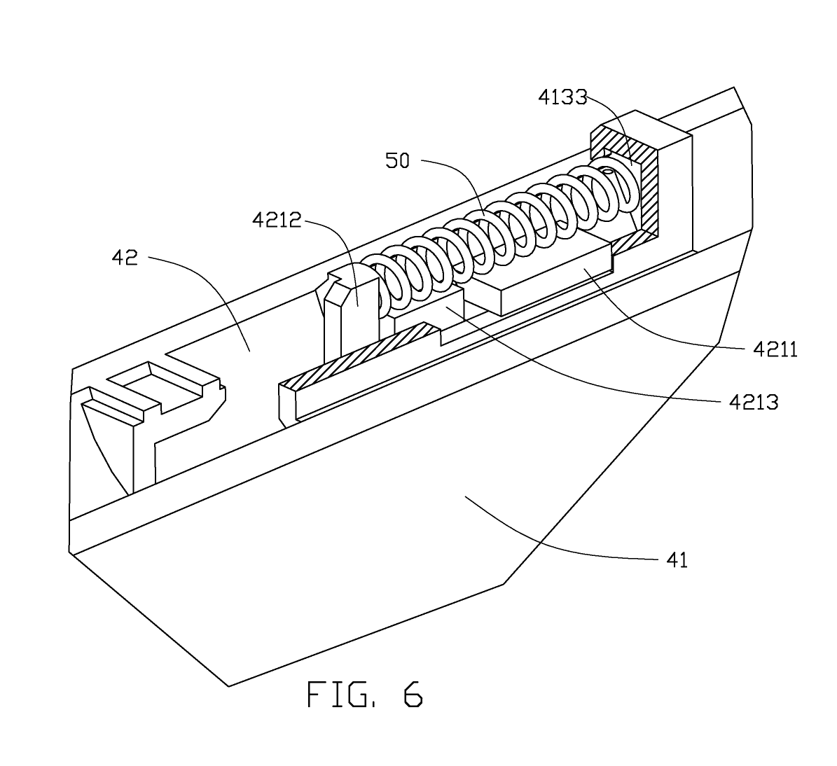

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

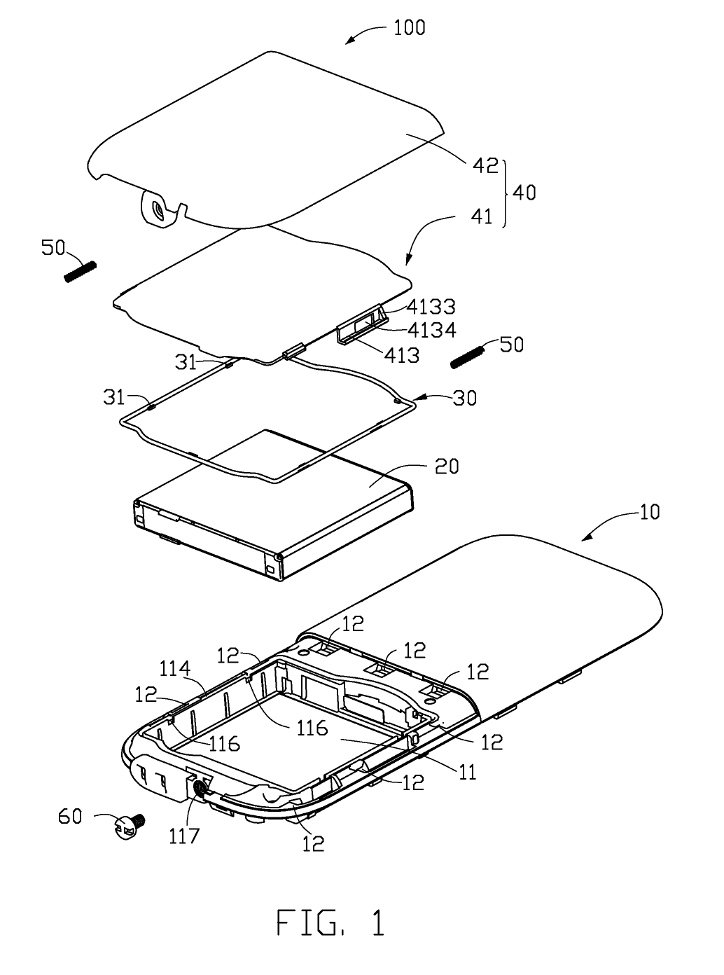

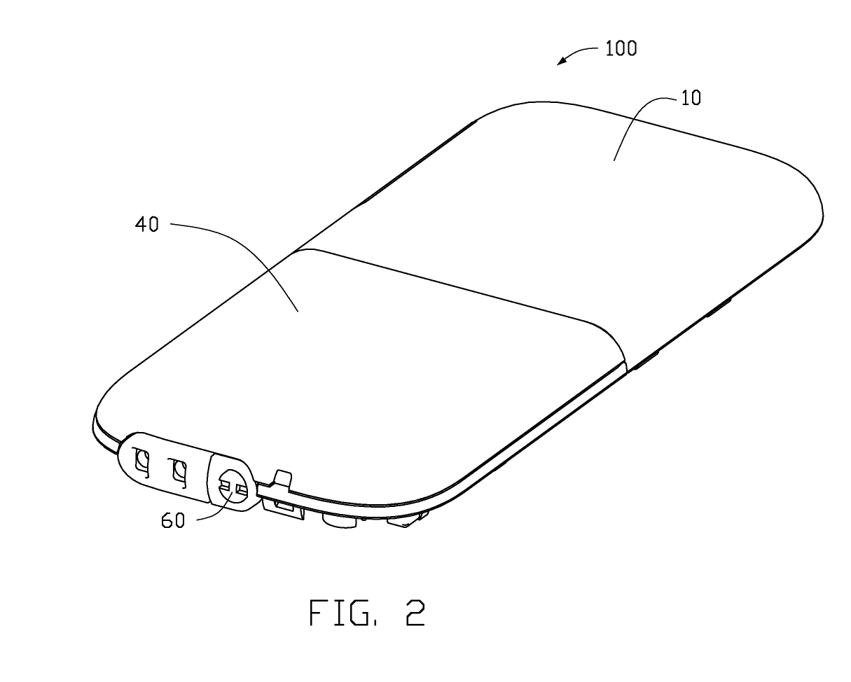

Referring to FIG. 1 and FIG. 2, a mobile device 100 comprises a housing 10, a battery 20, a gasket 30 and a lid assembly 40. The housing defines a receiving chamber 11 to receive the battery 20 and a receiving groove 114 configured around the receiving chamber 11. The gasket 30 is received in the receiving groove 114. The lid assembly 40 is attached to the housing 10 to cover the receiving chamber 11, as well as force the gasket 30.

In this embodiment, the housing 10 defines a plurality of latching slots 116 communicating the receiving groove 114 with the receiving chamber 11. The gasket 30 comprises a plurality of protrusions 31 engaging with the plurality of latching slots 116 respectively to position the gasket 30 in the receiving groove 114.

The housing 10 further defines a plurality of latching notches 12. The plurality of latching notches 12 are located surround the receiving chamber 11 to engage with the lid assembly 40, so as to fix the lid assembly 40 to the housing 10. In other embodiment, the housing 10 further defines a screw hole 117 in bottom part of the housing 10, to match with a screw 60 to fix the lid assembly 40 to the housing 10.

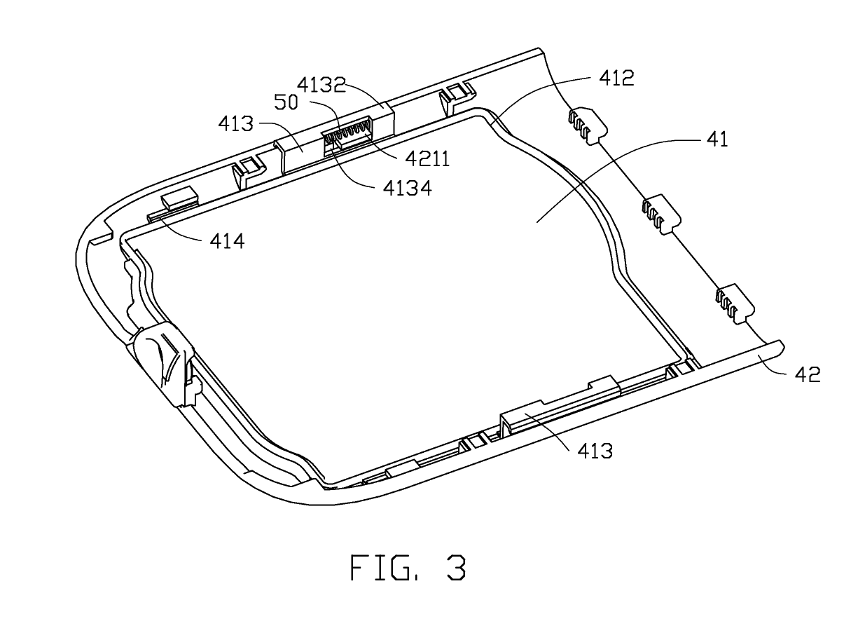

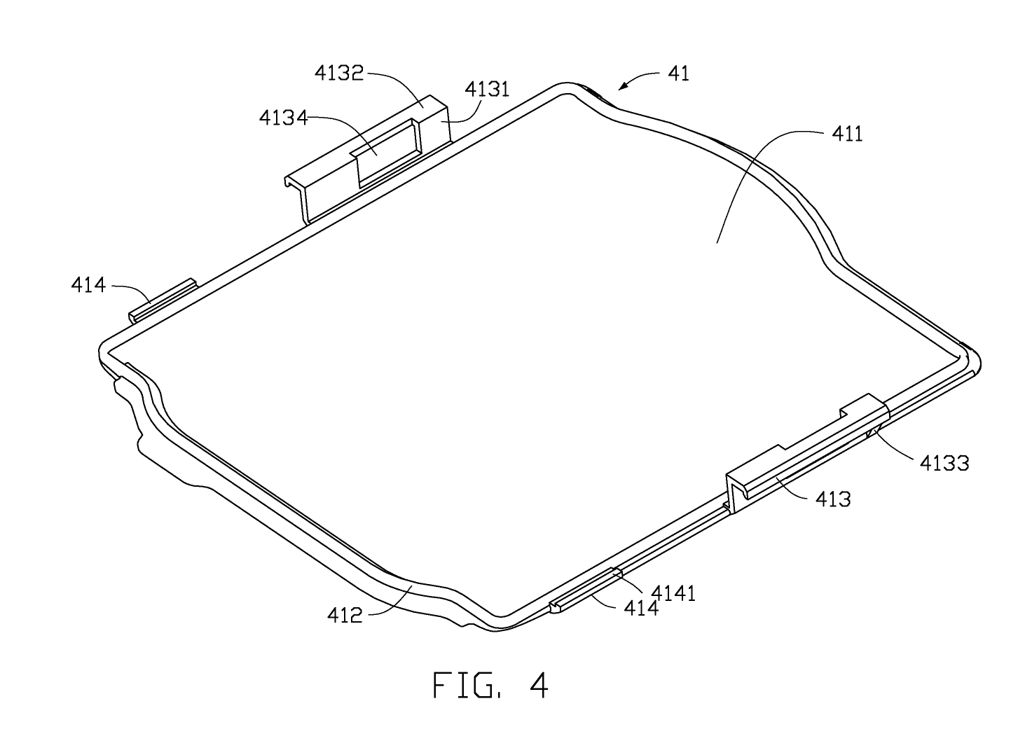

Referring to FIG. 3 and FIG. 4, the lid assembly 40 comprises a first lid 41 and second lid 42. The first lid 41 comprises a base plate 411 and a projecting rib 412 protruding from the base plate 41. The projecting rib 412 is used to engage with the receiving groove 114 to force the gasket 30 in the receiving groove 114. The second lid 42 is slideably attached to the first lid 41 and engages with the housing 10 to force the first lid 41 on the housing 10.

The first lid 41 further comprises a pair of first slidable portions 413 and a pair of first positioning portions 414 both located on two opposite periphery of the projecting rib 412 respectively. In this embodiment, each of the first slidable portions 413 comprises a first positioning board 4131, a second positioning board 4132, a first baffle board 4133 and a guiding groove 4134. Each of the first positioning board 4131 perpendicularly protrudes from edge of the base plate 411. Each of the second positioning board 4132 perpendicularly extends from one end of the first positioning board 4131 away from the edge of the base plate 411. Each of the first baffle boards 4133 is integrally formed between the first and second positioning boards 4131, 4132. Each of the guiding groove 4134 is defined in the first positioning board 4131. Each of the first positioning portions 414 comprises a latching strip 4141.

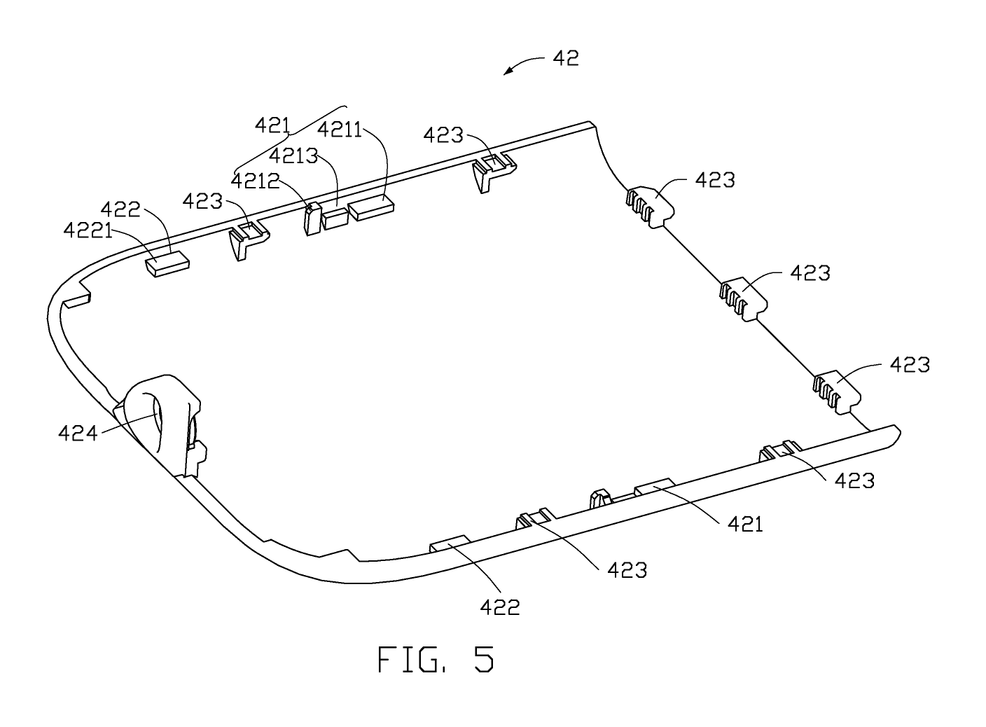

Referring to FIG. 5, the second lid 42 comprises a pair of second slidable portions 421 and a pair of second positioning portions 422 operable to engage with the pair of first slidable portions 413 and the pair of first positioning portions 414 respectively to slideably attach the first lid 41 to the second lid 42. Each of the second slidable portions 421 comprises a slidable block 4211 moveably received in corresponding one of the guiding grooves 4134 and a second baffle board 4212 opposite to corresponding one of the first baffle boards 4133.

The lid assembly 40 further comprises a pair of springs 50 urging between the first baffle boards 4133 of the first lid 41 and the second baffle boards 4212 of the second lid 42 correspondingly, and supported on the slidable blocks 4211. In this embodiment, the second lid 42 further comprises a pair of supporting portions 4213 located between the second baffle boards 4212 and the slidable blocks 4211 correspondingly to securely position the springs 50.

Each of the second positioning portions 422 comprises a protruding block 4221 defining a latching groove 4223 collectively with an inner surface 420 of the second lid 42. The latching strips 4141 are received in corresponding one of the latching grooves 4223 to position the second lid 42 to the first lid 41.

The second lid 42 comprises a plurality of latching blocks 423 engagable with the plurality of latching notches 12 respectively via moving the second lid 42 relatively to the housing 10. The second lid 42 further defines a mounted hole 424. The second lid 42 is fixed to the housing 10 via the screw 60 passing through the mounted hole 424 and screwed in the screw hole 117 of the housing 10.

In assembly, the battery 20 is installed into the receiving chamber 11. The gasket 30 is fixed into the receiving groove 114. The lid assembly 40 is disposed to cover the receiving chamber 11 after assembling the first lid 41 to the second lid 42 with the projecting rib 412 of the first lid 41 positioned in the receiving groove 114. Then press the lid assembly 40 to make the projecting rib 412 of the first lid 41 force the gasket 30 to prevent infiltration of water into the receiving chamber 11, and push the second lid 42 to make the plurality of latching blocks 423 move into and engage with the plurality of latching notches 12, thereby the lid assembly 40 is installed on the housing 10 with the springs 50 compressed. Ultimately, install the screw 60 to fix the lid assembly 40 to the housing.

The mobile device 100 has a sufficiently waterproof performance due to the engagement between the first lid 41 and the gasket 30. Furthermore, the first lid 41 being slidably attached to the second lid 42 to form an integrated lid assembly 40, thus, the batter lid 40 is installed to the housing 10 in a sufficiently easy operation, which includes only two actions: pressing and pushing.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A mobile device, comprising:
a housing, defining a receiving chamber to receive a battery and a receiving groove configured around the receiving chamber;
a gasket, received in the receiving groove; and
a lid assembly, attached to the housing to cover the receiving chamber, the lid assembly comprising a first lid and a second lid, the first lid comprising a projecting rib to engage with the receiving groove to force the gasket in the receiving groove, the second lid slideably attached to the first lid and engaged with the housing to force the first lid on the housing.

2. The mobile device as claimed in claim 1, wherein the first lid further comprises a pair of first slidable portions and a pair of first positioning portions located on two opposite periphery of the projecting rib respectively, the second lid comprises a pair of second slidable portions and a pair of second positioning portions engaging with the pair of first slidable portions and the pair of first positioning portions respectively to slideably attach the first lid to the second lid.

3. The mobile device as claimed in claim 2, wherein each of the first slidable portions defines a guiding groove, each of the second slidable portions comprises a slidable block moveably received in corresponding one of the guiding grooves, thereby the second lid moving relatively to the housing and the first lid positioned to the housing and ultimately locked in the housing.

4. The mobile device as claimed in claim 3, wherein the lid assembly further comprises a pair of springs urging between the first and second lid and supported on the slidable blocks.

5. The mobile device as claimed in claim 4, wherein each of the first slidable portions comprises a first baffle board, each of the second slidable portions comprises a second baffle board opposite to corresponding one of the first baffle boards, and the springs urge between the first and second baffle boards correspondingly.

6. The mobile device as claimed in claim 5, wherein the first lid comprises a base plate, each of the first slidable portions comprises a first positioning board perpendicularly protruding from the base plate and a second positioning board perpendicularly extending from the first positioning board, each of the guiding grooves is defined in the first positioning board, each of the first baffle boards integrally formed between the first and second positioning boards.

7. The mobile device as claimed in claim 6, wherein the second lid comprises a pair of supporting portions located between the second baffle boards and the slidable blocks correspondingly, to support the springs collectively with the slidable block.

8. The mobile device as claimed in claim 7, wherein each of the first positioning portions comprises a latching strip, each of the second positioning portions comprises a protruding block defining a latching groove collectively with an inner surface of the second lid, the latching strips are received in corresponding one of the latching grooves to position the second lid to the first lid.

9. The mobile device as claimed in claim 8, wherein the housing defines a plurality of latching notches, the second lid comprises a plurality of latching blocks engagable with the plurality of latching notches respectively via moving the second lid relatively to the housing.

10. The mobile device as claimed in claim 9, wherein the housing defines a screw hole, the second lid defines a mounted hole, the second lid is fixed to the housing via a screw passing through the mounted hole and screwed in the screw hole.

11. The mobile device as claimed in claim 10, wherein the housing defines a plurality of latching slots communicating the receiving groove with the receiving chamber, the gasket comprises a plurality of protrusions engaging with the plurality of latching slots respectively to position the gasket in the receiving groove.
